(19) United States
(12) Patent Application Publication
(10) Pub. No.: US 2011/0046831 A1
(43) Pub. Date: Feb. 24, 2011

(54) ELECTRICALLY POWERED MOTORIZED VEHICLE WITH CONTINUOUSLY VARIABLE TRANSMISSION AND COMBINED HYBRID SYSTEM

(76) Inventor: Anil ANANTHAKRISHNA, NORCROSS, GA (US)

Correspondence Address: SEAN LIAM KELLEHER;Kelleher IP PLLC, 4 Manorshire Dr, Ste 1, Fairport, NY, 14450, US

(21) Appl. No.: 12/704,525

(22) Filed: Feb. 11, 2010

Related U.S. Application Data
(60) Provisional application No. 61/151,831, filed on Feb. 11, 2009.

(51) Int. Cl. B60W 20/00; H02J 7/00; B60K 6/48; B60W 10/06; B60W 10/08

(52) U.S. Cl. 701/22; 320/109; 180/65.25; 180/65.265; 903/930

(57) ABSTRACT

The present invention describes an electric vehicle with hybrid drive system, which provides optimization of speed, power and maximizing efficiency levels. In one embodiment, the vehicle includes at least one driven wheel, an electric motor connected to the driven wheel through a fixed transmission system or a continuous variable transmission (CVT) unit, an internal combustion engine (ICE) connected to the driven wheel through a fixed transmission system or a CVT unit and a selector switch to select the modes of power supply to the electric vehicle. Further, the electric motor is powered by a battery power pack and the ICE is powered by a hydrocarbon fuels stored in a hydrocarbon fuel tank. Furthermore, the different position of selector switch provides different modes of the power supply to the vehicle. In another embodiment, the electric motor is adapted to be operated as a generator.

### RELATED APPLICATION

Benefit is claimed under 35 U.S.C. 119(e) to U.S. Provisional Application Ser. No. 61/151,831, entitled “ELECTRICALLY POWERED MOTORIZED VEHICLE WITH CONTINUOUSLY VARIABLE TRANSMISSION AND COMBINED HYBRID SYSTEM” by Anil Ananthakrishna, filed on Feb. 11, 2009, which is herein incorporated in its entirety by reference for all purposes.

### FIELD OF THE INVENTION

The present invention generally relates to the field of automobiles. Particularly, the present invention relates to an electric vehicle. More particularly, the present invention relates to a hybrid drive system in an electric vehicle which provides optimization of power and efficiency.

### BACKGROUND OF THE INVENTION

Motorized vehicles have become very popular especially for personal transport purpose. Motorized bikes in particular provide a riding experience similar to that of a non motorized, pedal powered bicycle, but without the manual exertion. Accordingly, individuals with limited physical stamina or debilitating medical conditions are able to participate and experience motoring, from which they might otherwise be precluded.

With regard to the motorized bikes and cars, electric vehicles provide an effortless form of transport regardless of the physical abilities of the riders. In addition, electric vehicles produce lower emission as compared to vehicles driven by conventional energy source.

Use of hybrid electric vehicles as the essential mode of personal transport has resulted in increased popularity. Use of electric vehicles within resorts and other tourist destinations has resulted in ease of access to amenities which have helped in improving the regular business. On the other hand, electrically powered motorized vehicles suffer from various disadvantages such as requirement of long hours for charging a battery, ability to run only on battery power and so on.

The electrically powered motorized vehicles have fixed transmission ratio that is not capable of overcoming varying gradients over which the vehicle might be traversing and at the same time provide high speeds. Also, by drawing heavy currents from the batteries, the entire system might be made to work under reduced efficiency yielding much lesser battery life. The application of sealed batteries for supply of power gives short time for recharging the batteries and also requires very less maintenance, similar to that of a non motorized pedal operated bicycle.

From the aforementioned, it becomes clear that there exists a need for an efficient electric vehicle with pure electric drive and combined hybrid drive system, which would provide optimization of speed, power and maximizing the efficiency levels of the vehicle.

### SUMMARY OF THE INVENTION

It is a primary object of the present invention to describe an electric vehicle with hybrid drive system, which provides optimization of speed, power and maximizing efficiency levels.

In one aspect, the electric vehicle with hybrid drive system includes at least one driven wheel, an electric motor connected to the driven wheel through a fixed transmission system or a continuous variable transmission (CVT) unit, an internal combustion engine (ICE) connected to the driven wheel through a fixed transmission system or a CVT unit and a selector switch to select the modes of power supply to the electric vehicle.

Accordingly the present invention relates to the vehicle, wherein the electric motor is powered by a battery power pack and the ICE is powered by a hydrocarbon fuels stored in a hydrocarbon fuel tank.

Accordingly the present invention relates to the vehicle, wherein the different position of selector switch provides different modes of the power supply to the vehicle, which comprises: at one position, the steering or handle bar of the vehicle gets locked; at another position, the vehicle would be powered by the electric motor; at another position, the vehicle would be powered by the ICE; and at another position the vehicle would be powered by the hybrid drives system utilizing optimal power from both the ICE and the electric motor.

Accordingly the present invention relates to the vehicle which includes the control system, which senses the charge in battery pack and communicates with an integrated battery management unit, the charging system, a RFID tag, a RFID reader and a battery monitoring unit for supplying charge to the batteries in the battery pack.

Alternatively, the present invention relates to the electric motor, which is also being adapted to be operated as a generator, wherein the battery pack is made up of hybrid chemistry batteries for receiving and storing electric energy from said electric motor when operated as a generator.

These and other objects, features and advantages of the present invention will become more apparent from the ensuing detailed description of the invention taken in conjunction with the accompanying drawings.

### BRIEF DESCRIPTION OF THE FIGURES

Example embodiments are illustrated by way of example and not limitation in the figures of the accompanying figures, in which like references indicate similar elements and in which:

FIG. 1 is a schematic side view of an electric vehicle with hybrid drive system, in accordance to the present invention.

Other features of the present embodiments will be apparent from the accompanying drawings and from the detailed description that follows

### DETAILED DESCRIPTION OF THE INVENTION

The preferred embodiments of the present invention will now be explained with reference to the accompanying drawings. It should be understood however that the disclosed embodiments are merely exemplary of the invention, which may be embodied in various forms. The following description and figures are not to be construed as limiting the invention and numerous specific details are described to provide a thorough understanding of the present invention, as the basis for the claims and as a basis for teaching one skilled in the art about making and/or using the invention. However in certain instances, well-known or conventional details are not described in order not to unnecessarily obscure the present invention in detail.

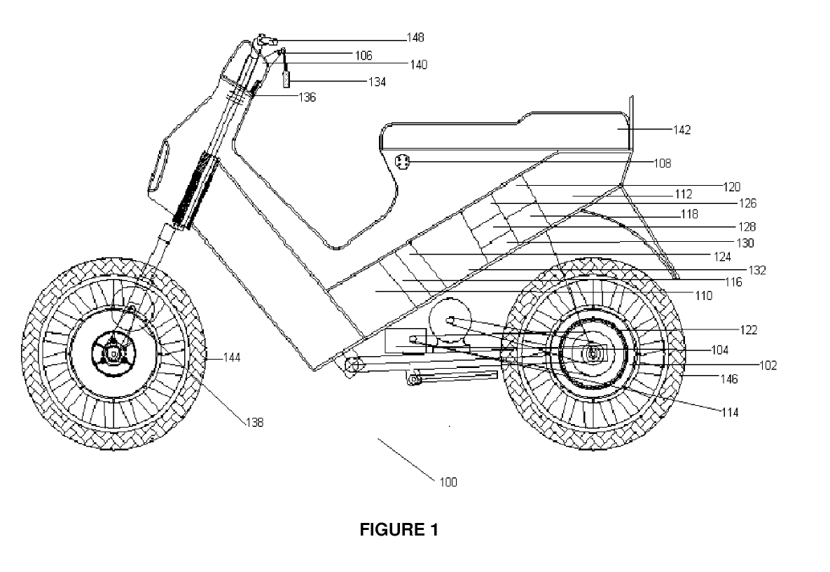

FIG. 1 is a schematic side view of an electric vehicle with a hybrid drive system, in accordance with the present invention. Particularly, the electric vehicle (100) includes a hybrid drive system. In one embodiment, the hybrid drive system includes an electric motor (102), an internal combustion engine (ICE) (104), a selector means such as a switch (106) a battery pack (110), a hydrocarbon fuel tank (112), a free wheel (114), a digital battery monitoring unit (116), a control system (118), a charging system (120), a CVT (122), and an integrated battery management unit (132) as coupled as shown in FIG. 1.

In one embodiment, the final drive is a brushless hub DC motor, hydraulically or pneumatically or mechanically connected to the driven wheel of the vehicle (100). The power to the electric motor (102) is supplied by a battery pack (110). The battery pack (110) is designed to accept pure DC fast charge. The battery pack (110) is made of combination of batteries such as, but not confined to the lead acid and lithium batteries. In one exemplary implementation, the lead acid battery is used to start the vehicle while the lithium batteries are used for driving the vehicle. The battery pack (110) is built in with low voltage batteries along with DC-DC converter or with high voltage batteries. If the battery pack (110) comprises of the low voltage batteries, then the DC-DC converter is used to convert the low voltage batteries to the required voltage to supply power to the electric motor (102).

In another embodiment, the vehicle (100) is powered by the ICE (104) by means of a hydrocarbon fuel such as, but not confined to gasoline or gaseous fuel or diesel. Further, the ICE (104) can be connected to the driven wheel. The hydrocarbon fuel can be stored in a fuel tank (112), which is placed beneath the seat (142) of the vehicle (100). In one exemplary implementation, the driven wheel can be a front wheel (144), powered by the battery pack (110) by means of an electronic controller which is actuated for speed and torque by a hand rotary throttle; or can be a rear wheel (146) which is connected by a chain or belt to the ICE (104) with a unique free wheel (114). The free wheel (114) can be incorporated either on the ICE (104) output shaft or on the driven wheel of the vehicle (100). Further, the free wheel (114) provides traction only in one direction when the ICE (104) is powering the driven wheel assembly which is integrated with the electric motor (102).

In one embodiment, the continuously variable transmission (CVT) (122) unit is embedded into driven wheel of the vehicle (100) or mounted separately and connected to the driven wheel. Further, the hybrid drive system has an electric motor (102) and the ICE (104) with fixed transmission to the CVT (122) of the driven wheel to maximize regenerative braking and cope with road load requirements while riding. The electric motor (102) and the ICE (104) are connected through a fixed transmission system or to the CVT (122) by means of chain or belt.

In one embodiment, the selector switch (106) placed near the handle bar (148) of the vehicle (100) provides power to the vehicle (100). At one position, the selector switch (106) essentially locks the steering or the handle bar of the vehicle (100). At another position, the vehicle (100) would run on the electric mode i.e., by utilizing power from the battery pack (110). At yet another position, the vehicle (100) would be running by ICE (102). Further, in one embodiment, at yet another position of the selection switch (106), the vehicle (100) would be running on the hybrid mode i.e. utilizing power from both ICE (102) and electric motor (102).

In operation, when the selector switch (106) in the electric vehicle (100) is turned at one position, the vehicle is powered by the electric source wherein the electric motor (102) powered by the battery pack to propel the vehicle. When the selector switch (106) is turned to the next position, the vehicle operates on the ICE (104) fueled by hydrocarbon fuel. Further, when the selector switch (106) is turned to yet another position, the vehicle is propelled by both ICE (104) and the electric motor (102) through the CVT (122) of the driven wheel through the transmission system.

Further in operation, the corresponding power is transmitted to the vehicle (100) using the CVT (122) unit which provides multiple torque ratios at varied gradients and load conditions so that the torque and speeds of the vehicle (100) are maintained at optimal levels. In addition, the electric motor (102) can act as a generator to supply power to the hybrid electric vehicle. The hybrid drive system may optionally contain an independent motor (138) (which could be electric powered, hydraulic, or pneumatic powered) which may be coupled to the ICE (104) connected by several means either by chain, gears, belts or drive shaft) to the driven wheel.

Further, the electric motor (102) acts as a generator whenever the electric motor (102) is not powered for traction or whenever the ICE (104) is utilized to propel the vehicle (100). The signal of the status is conveyed by electronic means by a switch in the mechanical brake lever or and independent switch. The signal is received by the electronic speed controller which transfers the generated power to the battery, thus, providing a means for charging of the battery in the vehicle as well as for regenerative braking. In general, the expression regenerative braking simply means that the system will provide effective use of the motor to function as a generator both charging the battery as well as bring the vehicle to halt. Through this, the user will be using less of mechanical brakes. The battery is connected by electrical wires to the electronic controller which is in turn connected by wires to the electric motor/generator.

In addition, the hybrid drive system includes a digital battery monitoring unit (116), which provides customized solution of combined topologies of single or multiple chemistry batteries. The digital battery management unit (116) monitors the power supplied to the hybrid electric vehicle (100) and integrates the need for battery maintenance of a single chemistry multiple cell battery, a hybrid chemistry multiple cell battery, a single chemistry single cell and hybrids of single chemistry cells. Further, the digital battery management unit (116) is capable of monitoring cells in series or cells in parallel, displaying battery capacities, communicating with the vehicle control system for appropriate action and also communicates to a on board display unit (140) normally placed on the dash board of the vehicle (100). Further, the digital battery management unit (116) protects the battery from any probable abuse by controlling parameters within the battery and also by communicating with the vehicle control system (118).

In one exemplary implementation, the hybrid drive system includes the charging system (120) with a rapid charging port (108), which is preferably placed beneath the seat (142) of the vehicle (100) to charge the battery pack (110). The charging system (120) provides means for conversion of power with the aid of switch mode conversion. By means of the switch mode conversion in the charging system (120), the vehicle (100) is capable of accepting different power packs and combinations of power packs (hybrid power) as required enhancing the efficiency of the vehicle. Also, the batteries in the battery pack (110) of the vehicle (100) can be charged by external charging station through connectors that can be plugged into the rapid charging port (108). The batteries in the external charging station can be made of single or multiple hybrid chemistry batteries.

Further, the charging system (120) has unique capability of real time monitoring and control of parameters, such as rate of change of voltage, rate of change of temperature, rate of change of current consumption. The chargers have the capability of handling power surges and fluctuations. The chargers are capable of replenishing charge to the electric vehicles in minutes. The high frequency and linear mode rapid chargers have algorithms that support all battery chemistries. The chargers have capability to sense vehicles with radio frequency identification (RFID) reader (134) and adapt to the required charging algorithm and to communicate with the vehicle on board integrated battery management system for replenishing required charge. Additionally, the chargers have capabilities of real time monitoring and control of parameters such as ±dV/▴t, ±d [symbol] /▴t and ±dA/▴t. The chargers detect rate of change in ascending and descending voltage with respect to time, rate of change in ascending and descending temperature with respect to time, and rate of change in ascending and descending current with respect to time.

Algorithms for fast charge of any combination of the hybrid battery such as
i. Lead acid+super capacitor
ii. Lead acid+NiMH
iii. Lead acid+lithium
iv. Stand alone lead acid.
v. Stand alone lithium.
vi. Stand alone NiMH
vii. Lithium+super capacitor.
viii. NiMH+super capacitor.

In addition, the on board DC-DC/DC-AC converter for drive train application in the charging system (120) enables transfer of energy from a high ampere hour capacity single cell power pack to a high voltage supply as required for electric power train operation. The on board device enables to deplete the complexity of multiple cell integration and interconnection for power pack building by converting the low voltage DC of a high capacity cell to required levels of AC or DC voltages.

In one embodiment, the fuel cell unit comprises of the methanol fuel cells (126), methanol fuel tank (128) and methanol battery charger (130) that provides means for charging traction battery. In operation, when the selector switch (106) in the electric vehicle (100) is at to the first position, the vehicle (100) is stationed. During this time, the fuel cell unit of the vehicle (100) charge the batteries in the battery pack (110).

In one exemplary implementation, the hybrid drive system includes a control system (118) that operates electronically or manually to control speed, power, acceleration, commutation in the vehicle. The control system (118) senses the condition of the battery with respect to voltage, current and energy stored as per the capacity of the battery and disconnects charging on the battery reaching full charge. The control system (118) communicates with the integrated battery management unit (132), the charging system (120), a RFID tag (136), a RFID reader (134), and the battery monitoring unit (116). The control system (118) is capable of adapting to the hybrid battery system and/or single chemistry batteries with/without super capacitors (124), regulating speed, regulating power, regulating energy consumption, regulating acceleration, regulating and varying transmission ratios on the CVT (122), adaptation of fixed maximum vehicle speed as selected by the rider, and adaptation to of fixed maximum vehicle acceleration as selected by the rider. Also, the control system (118) is capable of inducing regenerative breaking or freewheeling via the drive train mechanism. Further, the control system (118) also communicates to the on-board display unit (140) assisting speedometer, odometer and battery state of charge indicator.

In one exemplary implementation, the integrated battery management system (132) in the vehicle contains the lead acid battery with unique ability to fast recharge within few minutes. The super capacitors along with battery pack having the lead acid batteries cope for the required power surges in and out of the system. A hybrid battery system contains NiMH, lead acid, and lithium batteries for system optimization. Hybrid systems of the battery pack i.e the NiMH, lead acid, and lithium batteries have unique ability to fast charge within minutes. The super capacitors and the battery pack containing NiMH, lead acid, and lithium batteries supply power to the hybrid electric vehicle.

What is claimed is:

1. An electric vehicle with hybrid drive system comprising:
at least one driven wheel;
an electric motor connected to the driven wheel through a fixed transmission system or a continuous variable transmission (CVT) unit;
an internal combustion engine (ICE) connected to the driven wheel through a fixed transmission system or a continuous variable transmission CVT unit; and
a selector means to select the modes of power supply to the vehicle.

2. The vehicle of claim 1, wherein the driven wheel can be either a front wheel or a rear wheel of the vehicle or all wheels of the vehicle.

3. The vehicle of claim 1, wherein the electric motor is powered by a battery power pack and the ICE is powered by a hydrocarbon fuels stored in a hydrocarbon fuel tank.

4. The electric vehicle of claim 1, wherein the electric motor is also being adapted to be operated as a generator.

5. The vehicle of claim 3, wherein the battery pack is made up of hybrid chemistry batteries to supply stored electric energy to said electric motor, and for receiving and storing electric energy from said electric motor when operates as a generator.

6. The vehicle of claim 1, wherein the different position of selector means provides different modes of the power supply to the vehicle, which comprises:
at one position, the steering or handle bar of the vehicle gets locked;
at another position, the vehicle would powered by the electric motor;
at another position, the vehicle would powered by the ICE; and
at another position the vehicle would powered by the hybrid drives system utilizing optimal power from both the ICE and the electric motor.

7. The vehicle of claim 1, wherein a free wheel is incorporated either on the IC engine output shaft or on the driven wheel of the vehicle or on both drive side and driven side to provide traction in unidirection.

8. The vehicle of claim 1, wherein the free wheel is integrated with the electric motor to provide traction in unidirection.

12. The vehicle of claim 1, wherein the CVT is embedded into driven wheel of the vehicle or mounted separately and connected to the driven wheel.

9. The vehicle of claim 1, wherein the hybrid drive system includes a charging system to charge the batteries in the battery pack by means of conversion of low voltage direct current (DC) to high voltage DC or from low voltage DC to high voltage alternate current (AC) through the rapid charging port.

10. The vehicle of claim 1, wherein the hybrid drive system includes a control system for controlling the operation of the ICE and the electric motor such that uninterrupted power is supplied to the driven wheel.

11. The vehicle of claim 10, wherein the control system senses the charge in battery pack and communicates with an integrated battery management unit, the charging system, a RFID tag, a RFID reader and a battery monitoring unit for supplying charge to the batteries in the battery pack.

12. The vehicle of claim 11, wherein the digital battery monitoring unit comprises combined topology of single or multiple chemistry batteries to monitor the power supply to the vehicle and integrates the need for battery maintenance of a single chemistry multiple cell battery, a hybrid chemistry multiple cell battery, a single chemistry single cell and hybrid of single chemistry cells.

13. The vehicle of claim 11, wherein the digital battery management unit monitors the power supplied to the hybrid electric vehicle by the battery pack and communicates with the control system for rapid charging of the battery pack.
